(19) United States
(12) Patent Application Publication
(10) Pub. No.: US 2026/0093792 A1
(43) Pub. Date: Apr. 2, 2026

(54) SYSTEM AND METHOD FOR AUTHENTICATING A USER USING A DEVICE

(71) Applicant: Logistics and Supply Chain MultiTech R&D Centre Limited, Pok Fu Lam (HK)

(72) Inventors: Chi Hung Tong, Pok Fu Lam (HK); Kong Sit, Pok Fu Lam (HK); Chin Chiu Chung, Pok Fu Lam (HK)

(21) Appl. No.: 18/901,332

(22) Filed: Sep. 30, 2024

(51) Int. Cl. G06F 21/32

(52) U.S. Cl. CPC G06F 21/32

(57) ABSTRACT

The present invention relates to a system and method for authenticating a user using a device during a session. In one example the system for authenticating a user using a device during a session including: an input device configured to capture and transmit input data, a processor operatively coupled to the input device, the processor including an authentication engine executable by the processor, the authentication engine configured to: receive input data from the input device, detect a user's presence in the input data, start a countdown timer if no user presence is detected, continuously detect a user's presence during the countdown timer, end the session if a user's presence is not detected during the countdown timer and the timer reaches its end, and; re-authenticate a user and keep the session active if a user's presence is detected during the countdown timer.

### TECHNICAL FIELD

The present invention relates to a system and method for authenticating a user, in particular, but not limited to a system and method for continuously authenticating a user using a device during session.

### BACKGROUND

Mobile applications and the use of mobile devices, such as for example, smartphones and tablets has become ubiquitous in modern society. A growing number of individuals are using mobile devices and mobile applications executed on mobile devices. A growing number of elderly individuals are becoming proficient in using mobile applications.

Popular platforms such as Whatsapp, Facebook and YouTube are among the most used apps, especially among elderly individuals. These applications do not require users to log in and out with each use. With these applications, a user can log in once and remain logged in. Most users do not log off these applications after each use. Additionally, many mobile devices include the functionality to automatically store and load log in information. The “log out not needed” habit can inadvertently be formed among users, especially elderly users.

Self-service machines are becoming more common place. One example are self-service machines (i.e., self-service kiosks) that support cross boundary public services (CBPS) government initiative for residents living in the Guangdong-Hong-Kong-Macao greater bay area. These self-service machines and the CBPS initiative is particularly suited for retired persons and elderly persons.

This can “log out not needed” habit and use of various devices, especially by elderly individuals, can create a risk. The common risks are data privacy issues e.g., where a user's personal data may be open to attack or hacking. Additionally, not logging out opens can create session hijacking risks and potential scams set up by experienced hackers, putting user's sensitive information at risk.

These risks can be heightened when using the self-service machines. Self-service machines are not personal mobile devices. Self-service machines are set up in public facing environments and they serve multiple users. Cookies may be used when a user of the self-service machine accesses certain websites. By leveraging session cookies, criminals can take advantage of any active platforms that utilise SSO, which essentially allows them to move freely between numerous accounts. Through session hijacking, experienced hackers may be able to setup scammer's trap for the next user.

Session timeouts are one way to reduce or address risks of sensitive data leaks, especially for self-service machines. Relying on session timeout alone cannot solve the problems of users' data being exposed due to not logging off. This is because short timeouts may result in users being frequently logged out, which is inconvenient, disruptive to users, and results in a poor user experience.

### SUMMARY OF THE INVENTION

The present invention relates to a system and method for authenticating a user, in particular, but not limited to a system and method for continuously authenticating a user using a device. The device may be a computing device or a laptop or a self-service machine. The present invention also relates to a self-service machine that is adapted to implement a system and method for continuously authenticating a user during a session that the user is using the self-service machine. The self-service machine may include the system for authenticating a user that is adapted to continuously reauthenticate a user of the kiosk or log the user out if no user is detected.

The authentication system implemented in a device e.g., a self-service may be an intrusion detected continuous reauthentication that is adapted to detect a user's presence based on detecting an intrusion. An intrusion is human movement or detecting a human face or actions by a user when using the device. Intrusion can also mean detecting a human using the device or interacting with the device from input data.

In accordance with a first aspect there is provided, a system for authenticating a user using a device during a session comprising:
an input device configured to capture and transmit input data,
a processor operatively coupled to the input device, the processor comprising
an authentication engine executable by the processor,
the authentication engine configured to:
   receive input data from the input device,
   detect a user's presence in the input data,
   start a countdown timer if no user presence is detected,
   continuously detect a user's presence during the countdown timer,
   end the session if a user's presence is not detected during the countdown timer and the timer reaches its end, and;
   re-authenticate a user and keep the session active if a user's presence is detected during the countdown timer.

The system is advantageous provides enhanced security and privacy for users. By continuously monitoring and authenticating the presence of a user i.e., an active user, the system effectively addresses the challenges faced due to user's not logging off their devices.

In one example the authentication engine is configured to:
continuously reauthenticate the user each time a user's presence is detected while the countdown timer is on, and;
reset the countdown timer if a user is successfully re-authenticated and;
wherein the countdown timer duration is 1 minute or less.

The duration of the timer being 1 minute or less is advantageous because the system is fast at logging off a user or terminating the session, reducing risk of losing sensitive information and reducing the risk of hackers being able to access a user's sensitive information.

In one example the authentication engine is configured to: start the countdown timer if a user's presence is not detected and the user's role requires re-authentication.

In one example the authentication engine configured to: detect the user's presence by identifying an intrusion in the input data, and wherein the intrusion is a human intrusion.

In one example the input device is one or more of a thermal camera, video camera or infrared (IR) camera, wherein the input data is a video stream from the input device and wherein detecting an intrusion comprises detecting one or human features within the video stream.

In one example the authentication engine is configured to: detect human features in the input data, and wherein the human features detected are facial features and movement of the facial features.

In one example the authentication engine is configured to: authenticate a user by confirming the user is an active user based on the user's head position and one or more of facial expressions, movement of facial features, posture or arm movements, wherein the head position confirms the user is actively using the device.

In one example the authentication engine is configured to filter out non-human intrusions from the input data.

In another example, the authentication engine is configured authenticate a user as an active user by identifying biometric data in the input data and checking the biometric data against a database of authorized users.

In one example the authentication engine is configured to: simultaneously detect multiple users within the input data, identify the active user, and authenticate only the active user.

In one example the authentication engine comprises a three-layer architecture, wherein the three-layer architecture comprises a bottom layer, a middle layer and a top layer,
wherein the bottom layer comprises one or more video based secure device modules adapted to receive and process the input data,
wherein the middle layer comprises one or more information acquisition modules adapted to process visual data and manage session timeouts.
wherein the top layer comprises one or more logic and interface modules adapted to implement reauthentication process and interact with external systems.

In one example the authentication engine comprises:
a camera module and a real time computing module,
wherein the camera module is adapted to capture the video streams from a camera capturing a video stream of the front side of the device, wherein the camera captures a user's face,
wherein the real time computing module is adapted to process the video stream captured from the camera in substantially real time, wherein substantially real time is processing in milliseconds or less.

In one example the authentication engine comprises:
an intrusion detector,
a person tracking module,
a head position tolerance module,
a session timeout module,
wherein the intrusion detector is configured to process the video stream and detect a human intrusion,
wherein the person tracking module is configured to track the presence and movement of an active user within the input data, and update the active user's authentication status,
wherein head position tolerance module is configured to account for changes in a user's head position or posture,
wherein the session timeout module is configured to manage the countdown timer for automatic logout if the user is not detected within a duration of the countdown timer.

In one example the authentication engine comprises:
an action control module,
a processing logic module,
an object policy module,
an external system interface,
wherein the action control module is configured to manage the actions of the authentication engine, the action control module configured to at least log out of the session If the countdown timer reaches zero,
wherein the processing logic module is configured to apply the intrusion detection and continuous authentication based on the input from two or more of the other modules,
wherein the object policy module is configured defines one or more rules and/or policies that govern the authentication process, and wherein the rules and/or policies may be amended or updated,
wherein the external system interface is configured to allow the system to communicate with one or more other external systems.

In one example, the authentication engine is executable by the processor, and when the authentication engine is executed by the processor, the processor is configured to perform one or more of the functions described above.

In one example the device is a self-service machine comprising a user interface adapted to receive inputs from a user and present outputs to a user,
wherein the self-service machine is adapted to allow a user to perform any one or more the following operations:
   register a company,
   change company name,
   register for healthcare,
   complete immigration clearance,
   apply for a passport,
   apply for driver's license,
   renew a driver's license,
   apply for a certificate of absence of marriage record,
   apply for road permits,
   file an individual tax return,
   apply for welfare,
wherein the self-service machine is configured to implement the authentication engine as described earlier.

In one example, the authentication engine may be implemented by a processor of the self-service device. By continuously monitoring and reauthenticating the presence of a user as performed by the authentication engine within the self-service machine, the safety, security and privacy of the self-service machines is improved. This process of continuously monitoring a reauthenticating the user improves security of a user's data and reduces the chances of the user's data from being lost or stolen.

In accordance with a second aspect, there is provided a computer-implemented method for authenticating a user on a device during a session comprising:
receiving input data from the input device
detecting a user's presence in the input data,
starting a countdown timer if no user presence is detected,
continuously detecting a user's presence during the countdown timer,
ending the session if a user's presence is not detected during the countdown timer and the timer reaches its end, and;
re-authenticating a user and keep the session active if a user's presence is detected during the countdown timer.

In one example a user is continuously reauthenticated each time a user's presence is detected while the countdown timer is on, wherein the countdown timer is reset if a user is successfully re-authenticated, and; the countdown timer duration is 1 minute or less.

In one example the input data is a video stream from a thermal or IR camera,
wherein the user's presence is detected by identifying an intrusion in the input data, wherein the intrusion is a human intrusion,
wherein detecting an intrusion comprises detecting human features within the video stream, and;
wherein the human features detected are facial features and movement of the facial features.

In one example authenticating a user comprises confirming the user is an active user based on the user's head position and one or more of facial expressions, movement of facial features, posture or arm movements, wherein the head position confirms the user is actively using the device.

In one example, the method comprises the additional steps of:
updating the status of a user to not detected if no intrusion is detected in the input data,
checking if continuous reauthentication is required for the role of the user prior to starting a countdown timer,
starting a countdown timer if it is determined that continuous reauthentication is required for the role,
wherein the role corresponds to the function being performed by the user on the device.

The method described above is adapted to be performed during a session, which makes results in improved data security and privacy as compared to other methods where a user is authenticated once at the start of the session.

In one example a user is authenticated by confirming the user is an active user based on the user's head position and one or more of facial expressions, movement of facial features, posture or arm movements, wherein the head position confirms the user is actively using the device, and; wherein the authentication engine is configured to filter out non-human intrusions from the input data.

In another example, the user is authenticated as an active user by identifying biometric data in the input data and checking the biometric data against a database of authorized users.

In accordance with a further aspect, there is provided a data processing apparatus for authenticating a user on a device during a session comprising a processor for carrying out the method as described above.

In accordance with a further aspect, there is provided a computer program comprising instructions which, when the program is executed by a computer, cause the computer to carry out the method as described above.

In accordance with a further aspect, there is provided a computer-readable medium comprising instructions which, when executed by a computer, cause the computer to carry out the method as described above.

In accordance with a further aspect, there is provided a self-service machine for allowing a user to perform one or more functions comprising:
a body,
a user interface disposed on the body,
the user interface adapted to receive inputs from the user and present outputs or information to the user,
the user interface being angled such that a standing user or a user seated in a wheelchair can interact with the user interface,
a memory unit and a processor, the processor operatively coupled to the memory unit,
an input device configured to capture and transmit input data,
the processor operatively coupled to the input device,
the processor comprising an authentication engine executable by the processor,
the authentication engine configured to:
   receive input data from the input device,
   detect a user's presence in the input data,
   start a countdown timer if no user presence is detected,
   continuously detect a user's presence during the countdown timer,
   end the session if a user's presence is not detected during the countdown timer and the timer reaches its end, and;
   re-authenticate a user and keep the session active if a user's presence is detected during the countdown timer,
   continuously reauthenticate the user each time a user's presence is detected while the countdown timer is on, and;
   reset the countdown timer if a user is successfully re-authenticated, and;
   wherein the countdown timer duration is 1 minute or less.

In one example the body comprises a recessed portion to accommodate a wheelchair user's legs when the wheelchair user is adjacent the machine and using the machine, and the authentication engine of the self-service machine is as described in any one or of the statements above.

In accordance with a further aspect, there is provided a method for continuously authenticating a user on a self-service machine during a session comprising the steps of:
determining an intrusion of an active user is not detected,
changing a user's status to “not detected”
checking if there is a need for continuous reauthentication for the role of the user,
wherein the role of the user may be defined by any one or more of: services being accessed on the self-service machine or age or identity of the user,
if there no need for continuous reauthentication for the role of the user, then allow the user to continue using the self-service machine,
initiating a countdown timer if there is continuous reauthentication required for the role of the user, wherein the countdown timer is 1 minute or less in duration,
determine if the countdown timer has reached 0,
logout or exit the session on the self-service machine if the countdown timer reaches 0 and if no user is detected,
continuously monitor input data from an input device to check for user activity or an intrusion while the countdown timer is active,
allow the user to continue using the self-service machine if an intrusion or a user activity is detected during the countdown timer and the user is authenticated,
if no user activity or user intrusion is detected during the countdown timer, then check if the timer has reached zero, if so then exit the session and logout.

In accordance with a further aspect, there is provided a data processing apparatus for authenticating a user on a device during a session comprising a processor for carrying out the method as described above.

In accordance with a further aspect, there is provided a computer program comprising instructions which, when the program is executed by a computer, cause the computer to carry out the method as described above.

In accordance with a further aspect, there is provided a computer-readable medium comprising instructions which, when executed by a computer, cause the computer to carry out the method as described above.

In accordance with a further aspect, there is provided a self-service machine comprising a processor, a memory unit, a user interface to allow a user to provide inputs and present outputs to the user, an authentication engine executable by the processor, wherein the processor is configured to perform the method for continuously authenticating a user on a self-service machine as described above.

The term “comprising” (and its grammatical variations) as used herein are used in the inclusive sense of “having” or “including” and not in the sense of “consisting only of”.

The term session defines an operation session i.e., a duration of time between a user log on and log off. For self-service machines or other devices a user operates or interacts with the self-service machine or device during a session.

It is to be understood that, if any prior art information is referred to herein, such reference does not constitute an admission that the information forms a part of the common general knowledge in the art, in Australia or any other country.

### BRIEF DESCRIPTION OF THE DRAWINGS

Embodiments of the present invention will now be described, by way of example, with reference to the accompanying drawings in which:

FIG. 1 illustrates a schematic diagram of a system for authenticating a user using a device during a session.

FIG. 2 illustrates an example process flow of the system for authenticating a user as shown in FIG. 1.

FIG. 3 illustrates a flow chart of one example embodiment of a computer-implemented method for authenticating a user on a device during a session.

FIG. 4 illustrates a flow chart of a further example embodiment of a computer implemented method for authenticating a user on a device during a session.

FIG. 5 illustrates an example of a self-service machine that can be used by users e.g., elderly persons to access essential services.

FIG. 6 illustrates a side view of the self-service machine of FIG. 5.

FIG. 7 illustrates a schematic diagram of an authentication engine as used in a system for authenticating a user.

### DETAILED DESCRIPTION OF THE PREFERRED EMBODIMENTS

Self-service machines are becoming more common place. One example are self-service machines (i.e., self-service kiosks) that support cross boundary public services (CBPS) government initiative for residents living in the Guangdong-Hong Kong-Macao greater bay area. These self-service machines and the CBPS initiative is particularly suited for retired persons and elderly persons. Self-service machines are an example of devices that are used by users to access many essential services.

This can “log out not needed” habit in many users has been developed due to the increased use of mobile phones and mobile apps such as YouTube or Whatsapp that do not require a user to log off at the end of a session. This habit has become particularly common in elderly individuals. Many elderly users of these self-service machines often do not log off or exit. In such cases, there may be data privacy issues, session hijacking risks and potential scams set up by experienced hackers putting users' sensitive information at risk. Relying on session timeouts alone cannot solve the problem, as excessively short time outs can cause users to be frequently logged off making the process inconvenient and disruptive. On the other hand, long time outs that may reduce disruption again create risks of loss of sensitive information.

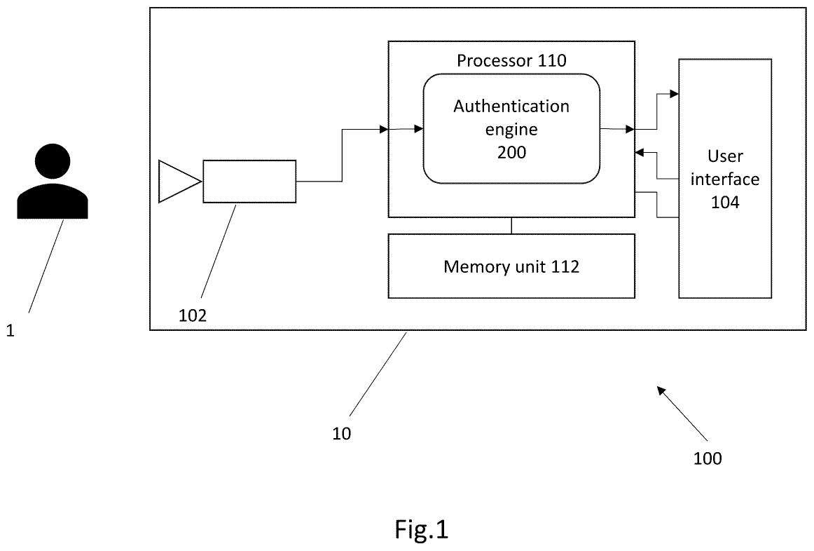

FIG. 1 shows an example of a system for authenticating a user 100 using a device 10 during a session. Referring to FIG. 1, the system for authenticating a user 100 using a device during a session comprising: an input device 102 configured to capture and transmit input data, a processor 110 operatively coupled to the input device, the processor comprising an authentication engine 200 executable by the processor, the authentication engine configured to: receive input data from the input device, detect a user's presence in the input data, start a countdown timer if no user presence is detected, continuously detect a user's presence during the countdown timer, end the session if a user's presence is not detected during the countdown timer and the timer reaches its end, and; re-authenticate a user and keep the session active if a user's presence is detected during the countdown timer.

In one example the authentication engine 200 is configured to: continuously reauthenticate the user each time a user's presence is detected while the countdown timer is on, and; reset the countdown timer if a user is successfully re-authenticated and; wherein the countdown timer duration is 1 minute or less.

The system is advantageous because it provides enhanced security and privacy for users. By continuously monitoring and authenticating the presence of a user i.e., an active user, the system effectively addresses the challenges faced due to user's not logging off their devices. The system is particularly useful when the device is a self-service machine. By continuously monitoring and authenticating the presence of a user, the system effectively addresses the challenges faced by users and other parties e.g., government officials in accessing and delivering essential services, especially delivering services via self-service machines.

The duration of the timer being 1 minute or less is advantageous because the system is fast at logging off a user or terminating the session. This fast log off or termination enhances security and reduces the chances hackers can hack the system and access a user's sensitive information. The continuous reauthentication while the timer is active ensures that if a user is detected, the timer is reset while if the user is not detected the session is terminated and the user is logged off quickly. The continuous reauthentication avoids the need for hardcoded session timeouts.

Referring to FIG. 1 a schematic of the system for continuously authenticating a user 100 while the user is using a device 10 is illustrated. The system 100 includes an input device 102 adapted to capture activities or intrusions by a user. The input device 102 is part of the device 10. Alternatively, the input device 102 may be separate to the device 10 and operatively coupled to the device 10.

The device 10 further includes at least a processor 110, a memory unit 112 and a user interface 104. The processor 110 is operatively coupled to the memory unit 112 and the user interface 104. The processor 110 comprises an authentication engine 200. The authentication engine 200 may be a software engine that is executable by the processor 110.

Alternatively, the authentication engine 200 may be a hardware module e.g., an ASIC or a microprocessor. The hardware module of the authentication engine 200 may be part of the processor 110.

The user interface 104 may be a touchscreen in one example form. In another example form, the user interface 104 may include a screen and a plurality of I/O (input/output) elements such as buttons, knobs, a keyboard etc. In a further example, a virtual keyboard may be presented on the screen to allow a user to input information. The user interface 104 can receive inputs from the user 1 and present outputs to the user 1.

In one example, the input device 102 is a camera. For example, the camera 102 may be a thermal camera or an infrared (IR) camera or a video camera. The camera 102 is adapted to record a user 1 interacting with the device 10 and transmit the video stream to the processor 110, where the authentication engine 200 is configured to process the video stream. The video data from the camera 102 is the input data. The input data may be streamed by the processor 110. In one example the camera video stream is received and processed in real time or near real time. The processor 110 may be adapted to continuously receive the video stream from the camera 102.

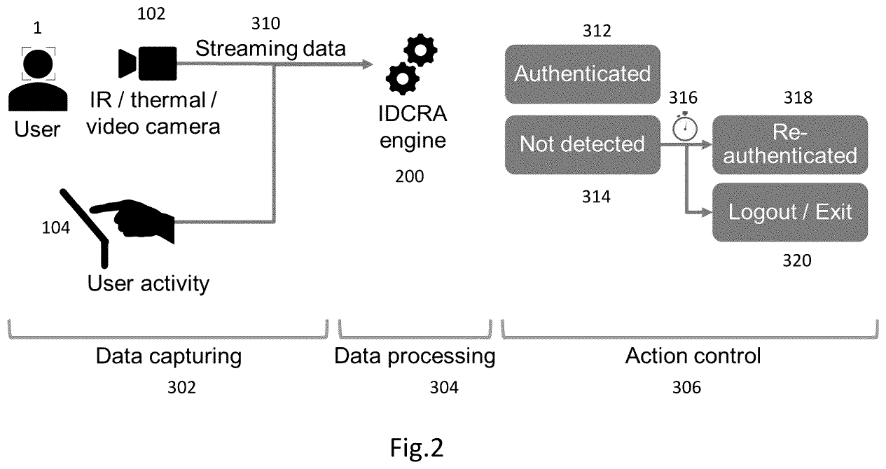

In one example the system 100 may comprise two input devices. In the illustrated example of FIG. 1 and FIG. 2, the camera 102 and the user interface 104 are both input devices. Data received from each device defines the input data received and processed by the authentication engine 200 in the processor 110. For example, the video stream from the camera 102 and input information from the user interface 104 may be processed by processor 110, and authentication engine 200.

FIG. 2 illustrates a system flow diagram 300 of the system for authenticating a user using a device 10. The system flow 300 illustrates functions of the components of the system 100.

Referring to FIG. 2, the system 100 performs a data capturing phase 302, a data processing phase 304 and an action control phase 306.

The authentication engine 200 is configured to receive input data from the input device and detect a user's presence in the input data. The authentication engine 200 is also configured to start a countdown timer if no user presence is detected, continuously detect a user's presence during the countdown timer. The authentication engine 200 is configured to end the session if a user's presence is not detected during the countdown timer and the timer reaches its end and re-authenticate a user and keep the session active if a user's presence is detected during the countdown timer. In the data capturing phase 302, input data 310 is received from the input devices at the authentication engine 200. The video data is streamed from the camera 102 that captures the user's 1 interactions with the device 10 or captures the user's movements while using the device 10. More specifically, the camera 102 is configured to capture facial data of the human user. The input data can also include inputs (i.e., user activity) from the user via the user interface 104. The input data is streamed to the authentication engine 200 for processing.

In the data processing phase 304, the authentication engine 200 is configured to process the data 314 and then output instructions to cause the actions in the action control phase 306. The authentication engine is an intrusion detected continuous re-authentication (IDCRA) engine that is configured to receive the input data, process the input data and continuously re-authenticate a user, especially if a user intrusion is detected.

The authentication engine 200 configured to detect the user's presence by identifying an intrusion in the input data during the data processing phase 304. The intrusion is a human intrusion. A human intrusion is detected by detecting the presence of a human in the video stream. Detecting an intrusion comprises detecting one or human features within the video stream. The authentication engine 200 is configured to identify or detect one or more human features within the video stream 310. Optionally, the authentication engine 200 may apply a facial recognition algorithm to identify and recognize human features in the video stream.

In one example the authentication engine 200 is configured to: detect human features in the input data, and wherein the human features detected are facial features and movement of the facial features. The authentication engine 200 is configured to recognize a human intrusion i.e., the presence of an active human user based detecting human features in the input data.

The authentication engine 200 does not rely on conventional face verification or identification methods as there is no prior registration for 1 to 1 or 1 to N matching. This is advantageous because the authentication engine 200 does not require prior information of the user and can recognize an active user based on the facial features and facial movements. The authentication engine 200 may recognize facial features and facial movements in the input data in real time.

Once the data is processed at phase 304, the authentication engine 200 is adapted to issue or transmit commands to cause one or more actions. In the action control phase 306, the authentication engine is configured to detect a user in the input data and authenticate 312 a user.

The authentication engine 200 is configured to authenticate the user using a suitable authentication method. In one example, the authentication engine 200 is configured to authenticate a user by confirming the user is an active user based on the user's head position and one or more of facial expressions, movement of facial features, posture or arm movements, wherein the head position confirms the user is actively using the device.

The authentication engine 200 is configured to filter out non-human intrusions from the input data. In one example the authentication engine 200 is configured to: simultaneously detect multiple users within the input data, identify the active user, and authenticate only the active user.

In an alternative example, the authentication engine 200 may be configured to authenticate a user as an active user by identifying biometric data in the input data and checking the biometric data against a database of authorized users.

If the user is authenticated 312 the user is allowed to continue to use the device 10. If the user is not detected 314 a countdown timer 316 is activated. The countdown timer 316 is short enough to prevent hackers from attacking the device. In one example, the countdown timer is 1 minute or less in length. If a user intrusion is detected while the countdown timer is active, the user is reauthenticated. The user may be reauthenticated by the authentication engine 200 based on the user's head position and one or more of facial expressions, movement of facial features, posture or arm movements. Alternatively biometric data of the user may be used to authenticate the user.

In one example the authentication engine 200 is configured to start the countdown timer if a user's presence is not detected and the user's role requires re-authentication.

If the user is successfully re-authenticated at 318, the timer is terminated, and the authenticated user is allowed to continue using the device. Alternatively, the timer may be reset. The timer may be initiated again if the user is not detected within the session. If a new user is detected, then the system 100 may start a new session and automatically log off the old user.

If the user is not reauthenticated successfully, i.e., the reauthentication fails, then the authentication engine 200 is configured to exit the session 320 or log off the current session. The system may be logged off 320 in 1 minute or less if no user is detected during the countdown timer or if a user cannot be re-authenticated. This is advantageous because the session is ended before any hacker attack or loss of personal or sensitive information.

The authentication engine 200 may be configured to continuously check for a user and reauthenticate a user as required. This is advantageous because the system 100 mitigates risks associated with unattended sessions. The system 100 also maintains session continuity only when the user is present i.e., when the user is detected and authenticated providing a safe system and improved user experience. The system 100 and authentication engine 200 operates discreetly without interfering with the user's interactions with the device.

The system 100 is advantageous provides enhanced security and privacy for users. By continuously monitoring and authenticating the presence of a user i.e., an active user, the system effectively addresses the challenges faced due to user's not logging off their devices. The duration of the timer being 1 minute or less is advantageous because the system is fast at logging off a user or terminating the session, reducing risk of losing sensitive information and reducing the risk of hackers being able to access a user's sensitive information.

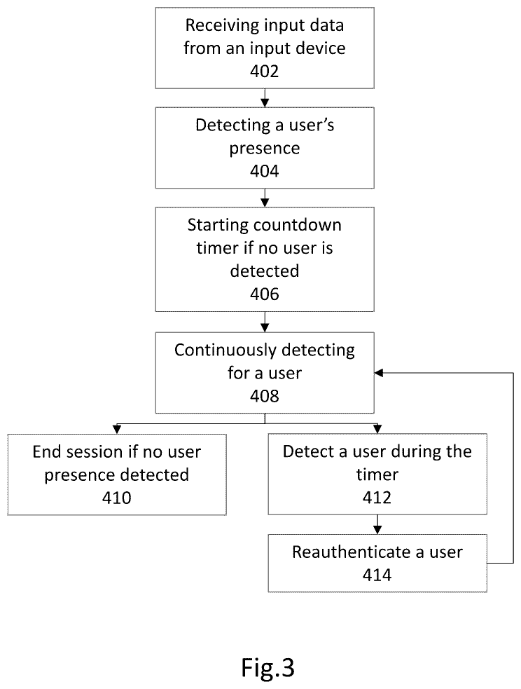

FIG. 3 illustrates a flow chart of one example embodiment of a computer-implemented method for authenticating a user on a device during a session. The method 400 commences at step 402. Step 402 comprises receiving input data from the input device. Step 404 comprises detecting a user's presence in the input data. Step 406 comprises starting a countdown timer if no user presence is detected. Step 408 comprises continuously detecting a user's presence during the countdown timer. Step 410 comprises ending the session if a user's presence is not detected during the countdown timer and the timer reaches its end. Step 412 comprises detecting a user while the timer is active. Step 414 comprises re-authenticating a detected user and keep the session active if a user's presence is detected during the countdown timer.

In one example a user is continuously reauthenticated each time a user's presence is detected while the countdown timer is on, wherein the countdown timer is reset if a user is successfully re-authenticated, and; the countdown timer duration is 1 minute or less. The method 400 may be implemented or executed by the authentication engine 200. The method 400 may be executed on a self-service machine or other device.

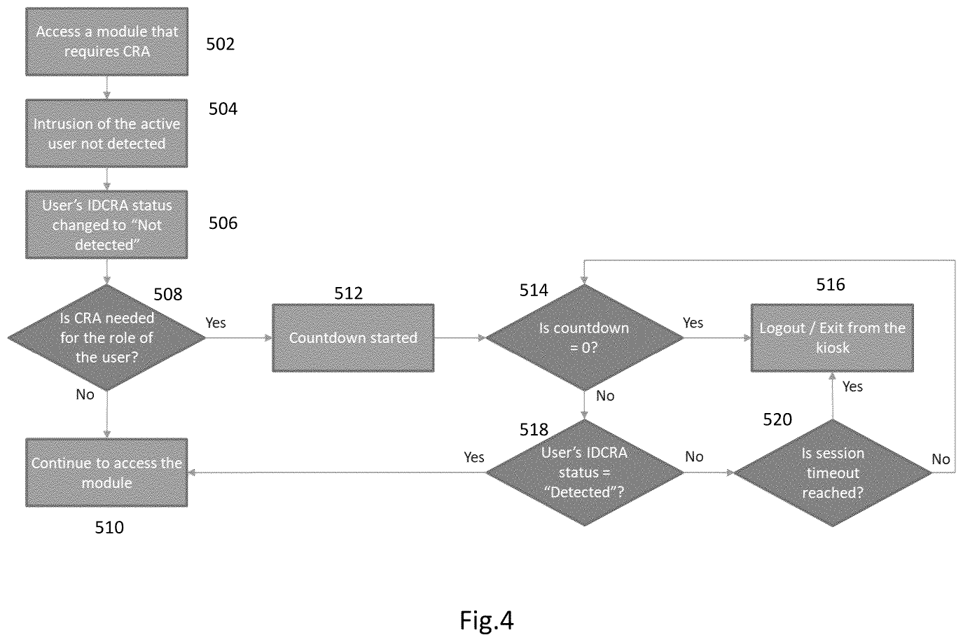

FIG. 4 illustrates a flow chart of a further example embodiment of a computer implemented method for authenticating a user 500 on a device 10 during a session. Referring to FIG. 4, the method at step 502 accesses a module that requires continuous reauthentication. Step 504 comprises beings with determining the user's presence i.e., an intrusion. At step 504 an intrusion of an active user is not detected.

An intrusion may be detected by identifying one or human features within the video stream from the camera 102. An intrusion may be detected if there are inputs via the user interface 104. An intrusion may also be detected if human features are identified in the video stream and user inputs are received from the interface 104.

Step 506 comprises updating a user's status to “not detected” if no human intrusion (i.e., human presence or human activity) is detected. Step 508 comprises checking if continuous reauthentication is needed for the role of the user. If no reauthentication is needed, the method goes to step 510. Step 510 comprises continuing to allow a user access to the module or device 10.

If a user's role requires reauthentication at step 508 and a user is undetected, the method starts a countdown timer at step 512. The countdown timer at step 512 may be for 1 minute or less. In one example the time may be for 1 minute. In another example, the countdown timer may be for 40 seconds. In another example, the timer may be for 30 seconds.

Step 514 comprises checking if the countdown timer has reached 0. If the countdown timer reaches 0 and no user is detected, the session is ended or logged off at step 516. The user may be logged off the self-service machine or device 10 if the countdown timer reaches 0.

At step 518 if a user is detected i.e., a human intrusion is detected while the countdown timer is active the user reauthenticated and the user is allowed to continue using the device at step 510. If no user is detected at step 518 the method goes to step 520. Step 520 comprises checking if session timeout has reached. If yes, the method proceeds to step 516 where a user is logged off. If the timeout has not reached the method returns to step 514 to check if the countdown timer has reached 0. The method comprises continuously reauthenticating a person while a countdown timer is active. The method also requires activating a countdown timer if no user is detected to log a user off and end the session if the user has left the device unattended.

The method 500 may be executed in the authentication engine 200. The authentication engine 20 may define the method steps as computer executable code that may be executed by a processor 110. A device 10 e.g., a self-service machine may execute an authentication engine 200 thereby causing the self-service machine to execute the method 500.

The device 10 may be a self-service machine. Self-service machines are used in some cities to allow users to access various essential services. The self-service machines provide users, especially elderly users an internet connected device since many elderly users may not have internet connected devices. The self-service machines may also simplify access to essential services. In one example, the Cross Boundary Public Services (CBPS) government initiative for the residents living in the Guangdong-Hong Kong-Macao Greater Bay Area (GBA) are delivered through self-service machines installed at several locations in the GBA. The self-service machines are particularly useful for elderly users. The number of elderly persons living in the Guangdong region has increased from 70,000 to 80,000 from 2013 to 2020.

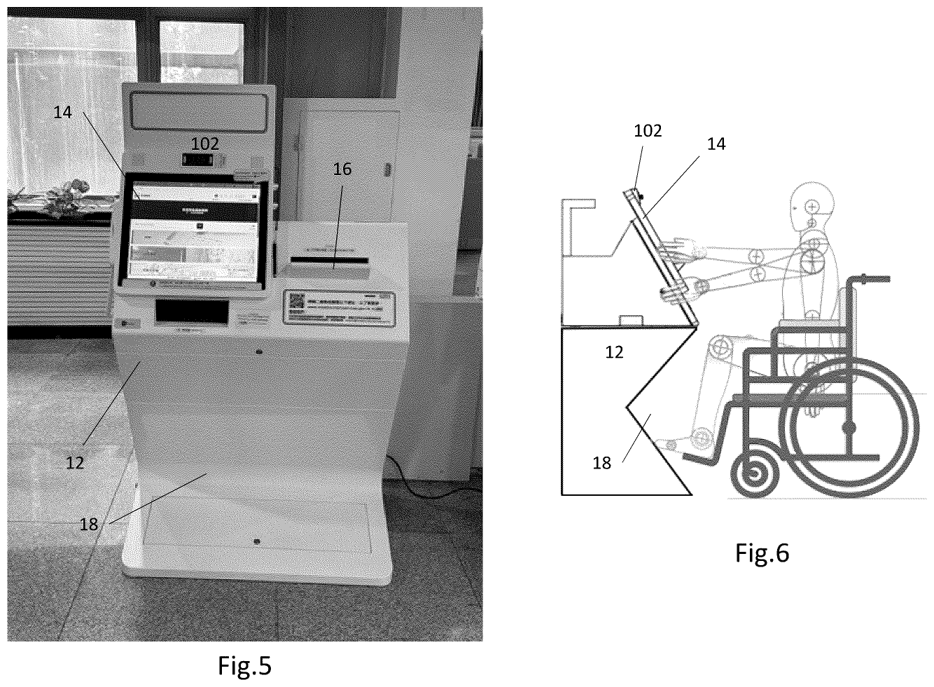

FIG. 5 illustrates an example of a self-service machine 10 that can be used by users e.g., elderly persons to access essential services. The self-service machine 10 may be adapted to allow a user to perform any one or more the following operations: register a company, change company name, register for healthcare, complete immigration clearance, apply for a passport, apply for driver's license, renew a driver's license, apply for a certificate of absence of marriage record, apply for road permits, file an individual tax return, and apply for welfare. Other functions and services may also be offered.

FIG. 5 illustrates a front view of the self-service machine 10. Referring to FIG. 5, the self-service machine 10 comprises a body 12 and a user interface 14 disposed on the body 12. The user interface 14 may be adapted to receive inputs from the user and present outputs or information to the user. The user interface may be a touchscreen as shown in FIG. 5. The user interface 14 may alternatively be a screen and other I/O elements such as a keyboard or buttons. The self-service machine 10 may also include card readers 16 to read credit cards or debit cards, drivers licenses, personal ID cards or other cards. The machine 10 may also include one or more slots to insert case. The self-service machine 10 may also include an inbuilt camera and/or a scanner to scan documents.

The user interface 14 may be angled such that a standing user or a user seated in a wheelchair can interact with the user interface. FIG. 6 illustrates an example of the angled user interface 14. The user interface may further be configured to slide vertically such that the interface is height adjustable, as shown in FIG. 6. The self-service machine 10 may comprise a memory unit 114 and a processor 110. The processor operatively coupled to the memory unit. The self-service machine 10 may comprise an input device 102 that is configured to capture and transmit input data. The processor may comprise the authentication engine as described earlier. The authentication engine 200 may reside in the self-service machine and may function as described herein.

In one example the body 12 comprises a recessed portion 18 to accommodate a wheelchair user's legs when the wheelchair user is adjacent the machine and using the machine.

The self-service machine also comprises an input device 102. In the illustrated example the self-service machine 10 comprises a camera 102 mounted on the front face of the machine 10. The camera 102 captures video i.e., covers the front side of the machine focusing on the user's face. The camera 102 is mounted at an angle that the user's face can be captured when the user is interacting with the self-service machine 10.

In alternative forms, the device 10 may be a mobile device e.g., a smartphone or tablet or other device. In one example the device 10 including the authentication engine 200 and processor 110 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

The device 10 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The computing apparatus may comprise one or more GPUs being operatively coupled to the CPU (i.e., processor). The computing apparatus may comprise additional hardware elements operatively coupled to the CPU and/or the GPU to provide the computing apparatus components needed to implement a machine learning network or machine learning model. The learning network or model may be stored in a memory unit e.g., ROM.

In one example the authentication engine 200 comprises a three layer architecture, wherein the three-layer architecture comprises a bottom layer, a middle layer and a top layer. In this example the bottom layer comprises one or more video based secure device modules adapted to receive and process the input data. The middle layer comprises one or more information acquisition modules adapted to process visual data and manage session timeouts. In this example the top layer comprises one or more logic and interface modules adapted to implement reauthentication process and interact with external systems.

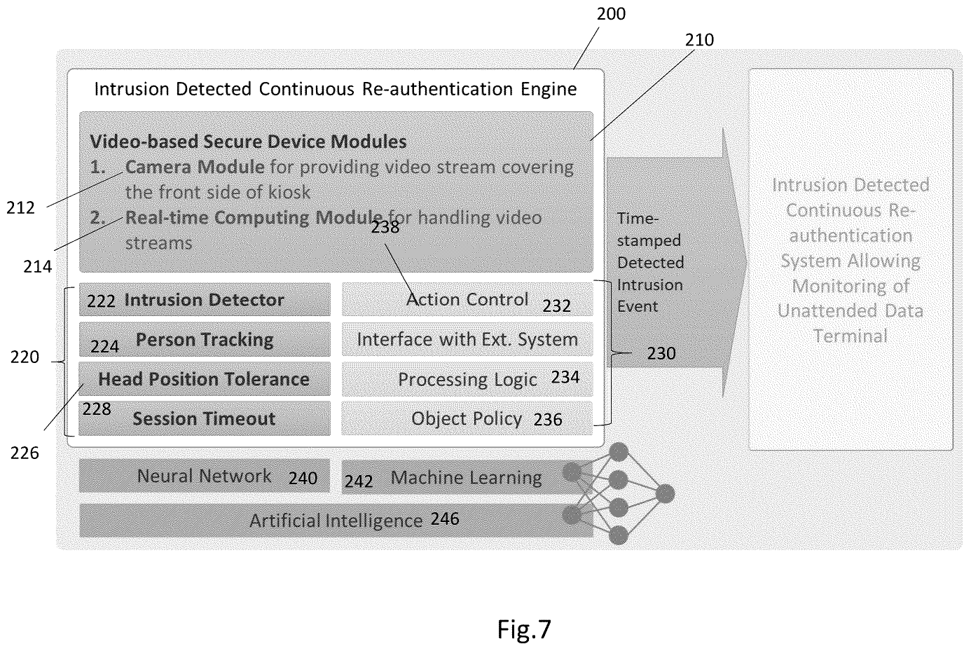

FIG. 7 illustrates an example system architecture of the authentication engine 200. The authentication engine 200 comprises three layers. The bottom layer 210 comprises a camera module 212 and a real time computing module 214. The camera module 212 is a module that captures the video streams from the camera 102. the camera module 212 is adapted to capture the video streams from a camera capturing a video stream of the front side of the device, wherein the camera captures a user's face. The real time computing module 214 is adapted to process the video stream captured from the camera in substantially real time, wherein substantially real time is processing in milliseconds or less.

The middle layer 220 comprises an intrusion detector 222, a person tracking module 224, a head position tolerance module 226 and a session timeout module 228. The intrusion detector 222 is configured to process the video stream and detect a human intrusion. The intrusion detector 222 may be configured to detect an intrusion as described earlier. The intrusion detector 222 is configured to detect one or human features within the video stream. The person tracking module 224 is configured to track the presence and movement of an active user within the input data and update the active user's authentication status. The head position tolerance module 226 is configured to account for changes in a user's head position or posture. This ensures the authentication process remains flexible and user friendly. Further the head position tolerance module ensures that head movements or head tilting etc. detected in the video stream is accounted for. The session timeout module 228 is configured to manage the countdown timer for automatic logout if the user is not detected within a duration of the countdown timer.

The top layer 230 of the authentication engine comprises an action control module 232, a processing logic module 234, an object policy module 236, and an external system interface 238. Referring to FIG. 7, the action control module 232 is configured to manage the actions of the authentication engine. The action control module 232 is configured to at least log out of the session If the countdown timer reaches zero. The processing logic module 234 is configured to apply the intrusion detection and continuous authentication based on the input from two or more of the other modules. The object policy module 236 is configured defines one or more rules and/or policies that govern the authentication process, and wherein the rules and/or policies may be amended or updated. The object policy module 236 may define critical points of access security and other policies around access and reauthentication. An authorized party can change or amend the stored policies. The external system interface 238 is configured to allow the system to communicate with one or more other external systems.

The authentication engine 200 may also include a neural network 240 and/or a machine learning module 242. The machine learning network or neural network can be trained to recognize or identify a human intrusion e.g., the presence of a human. The networks may also be trained to identify or recognize facial features and movements of facial features to identify an active user. The authentication engine 200 may also include an artificial intelligence (AI) module 244. The AI module 244 may be trained to perform features such as assisting a user to perform the services offered in the device. The neural network, AI module or machine learning network may be used by the other modules to perform the functions of the modules. The neural network 240, AI module 244 and machine learning module 242 may be optional components.

In one example, the authentication engine 200 is executable by the processor 110. The authentication engine 200 may be executed by the processor 110 and the processor may be configured to perform one or more of the functions described herein.

As shown in FIG. 7, the authentication engine 200 is adapted to allows monitoring of unattended device e.g., an unattended self-service machine 10. The authentication engine 200 is used as part of an authentication system 100 which can be used to monitor unattended self-service machines and quickly log off or exit a session if no user is authenticated within a short period of time. The system is advantageous provides enhanced security and privacy for users. The authentication system 100 and authentication engine 200 is designed to provide enhanced security and privacy for self-service machines by continuously monitoring and authenticating the presence of an active user. By continuously monitoring and authenticating the presence of a user i.e., an active user, the system effectively addresses the challenges faced due to user's not logging off their devices.

The authentication engine 200 is configured to recognize non-human objects or environmental factors that could potentially trigger false intrusion alerts. The intrusion detector 222 may be configured to filter out non-human objects or environmental factors e.g., wind or vibrations. The authentication engine's algorithms are designed to focus on detecting human presence and minimize the impact of non-human object intrusions on the overall accuracy of the authentication process. The neural network or machine learning modules may be leveraged or used by the intrusion detector to detect human intrusions.

The authentication engine 200 does not rely on conventional face verification or identification methods, as there is no prior 1 to 1 or 1 to N matching. The engine 200 is designed to recognize the presence of an active human user based on facial features and movements without requiring prior information about the user. This makes the authentication engine 200 flexible and usable in any device. The verification of a user without any need for prior information makes the system operable with a wide number of users.

The authentication engine considers that users can change their face position due to various factors e.g., making gestures or engaging in typical human behavior. The person tracking module 224 and the head position tolerance module 226 are configured to account for these changes ensuring that a user's presence is accurately detected and authenticated even if the user's face position changes. In one optional example a neural network 240 may be trained and utilized to identify a person's facial features even if a user moves their face e.g., by applying a facial recognition algorithm.

The authentication engine 200 may be capable of processing multiple faces. In some use cases, multiple people may be present near the device e.g., a self-service machine simultaneously. The authentication engine 200 is configured to accurately recognize and authenticate an active user while also monitoring the presence of any companions or other individuals in the vicinity. This helps to maintain the security and privacy of the self-service machine even in crowded or busy environments. The person tracking module 224 and intrusion detector 222 may be configured or trained to detect an active user while also tracking other individuals.

The authentication system 100 is an innovative and robust solution for enhancing the security and privacy of self-service machines. By considering potential instructions by non-human objects, avoiding traditional face verification methods, tolerating face position changes and processing multiple faces, the authentication engine 200 ensures continuous and accurate authentication of active users in various situations and environments.

The authentication engine 200 is advantageous because they bolster data privacy and security. The system mitigates risks associated with unattended sessions on a device e.g., a self-service machine. The system for authenticating a user and authentication engine are advantageous because the system maintains session continuity only when the user is present, and if the user is not present the session is ended. The authentication engine operates discreetly without user awareness i.e., in the background reducing any interference to the user. The authentication engine 200 operates in a contactless manner promoting hygiene and reducing infectious disease transmission making the system and engine advantageous. The authentication engine is compatible with webcams and existing hardware of devices such as self-service machines, hence not requiring additional hardware.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

One or more of the components and functions illustrated the figures may be rearranged and/or combined into a single component or embodied in several components without departing from the scope of the invention. Additional elements or components may also be added without departing from the scope of the invention. Additionally, the features described herein may be implemented in software, hardware, as a business method, and/or combination thereof.

1. A system for authenticating a user using a device during a session comprising:
an input device configured to capture and transmit input data,
a processor operatively coupled to the input device, the processor comprising an authentication engine executable by the processor,
the authentication engine configured to:
receive input data from the input device,
detect a user's presence in the input data,
start a countdown timer if no user presence is detected,
continuously detect a user's presence during the countdown timer,
end the session if a user's presence is not detected during the countdown timer and the timer reaches its end, and;
re-authenticate a user and keep the session active if a user's presence is detected during the countdown timer.

2. The system of claim 1 wherein the authentication engine is configured to:
continuously reauthenticate the user each time a user's presence is detected while the countdown timer is on, and;
reset the countdown timer if a user is successfully re-authenticated and;
wherein the countdown timer duration is 1 minute or less.

3. The system of claim 2, wherein the authentication engine is configured to:
start the countdown timer if a user's presence is not detected and the user's role requires re-authentication.

4. The system of claim 3, wherein the authentication engine configured to: detect the user's presence by identifying an intrusion in the input data, and wherein the intrusion is a human intrusion.

5. The system of claim 4, wherein the input device is one or more of a thermal camera, video camera or infrared (IR) camera, wherein the input data is a video stream from the input device and wherein detecting an intrusion comprises detecting one or human features within the video stream.

6. The system of claim 5, wherein the authentication engine is configured to: detect human features in the input data, and wherein the human features detected are facial features and movement of the facial features.

7. The system of claim 4, wherein the authentication engine is configured to: authenticate a user by confirming the user is an active user based on the user's head position and one or more of facial expressions, movement of facial features, posture or arm movements, wherein the head position confirms the user is actively using the device, and;
wherein the authentication engine is configured to filter out non-human intrusions from the input data.

8. The system of claim 7, wherein the authentication engine is configured to: simultaneously detect multiple users within the input data, identify the active user, and authenticate only the active user.

9. The system of claim 4, wherein the authentication engine comprises a three-layer architecture, wherein the three-layer architecture comprises a bottom layer, a middle layer and a top layer,
wherein the bottom layer comprises one or more video based secure device modules adapted to receive and process the input data,
wherein the middle layer comprises one or more information acquisition modules adapted to process visual data and manage session timeouts,
wherein the top layer comprises one or more logic and interface modules adapted to implement reauthentication process and interact with external systems.

10. The system of claim 5, wherein the authentication engine comprises:
a camera module and a real time computing module,
wherein the camera module is adapted to capture the video streams from a camera capturing a video stream of the front side of the device, wherein the camera captures a user's face,
wherein the real time computing module is adapted to process the video stream captured from the camera in substantially real time, wherein substantially real time is processing in milliseconds or less.

11. The system of claim 10, wherein the authentication engine comprises:
an intrusion detector,
a person tracking module,
a head position tolerance module,
a session timeout module,
wherein the intrusion detector is configured to process the video stream and detect a human intrusion,
wherein the person tracking module is configured to track the presence and movement of an active user within the input data, and update the active user's authentication status,
wherein head position tolerance module is configured to account for changes in a user's head position or posture,
wherein the session timeout module is configured to manage the countdown timer for automatic logout if the user is not detected within a duration of the countdown timer.

12. The system of claim 11, wherein the authentication engine comprises:
an action control module,
a processing logic module,
an object policy module,
an external system interface,
wherein the action control module is configured to manage the actions of the authentication engine, the action control module configured to at least log out of the session If the countdown timer reaches zero,
wherein the processing logic module is configured to apply the intrusion detection and continuous authentication based on the input from two or more of the other modules,
wherein the object policy module is configured defines one or more rules and/or policies that govern the authentication process, and wherein the rules and/or policies may be amended or updated,
wherein the external system interface is configured to allow the system to communicate with one or more other external systems.

13. The system of claim 1, wherein the device is a self-service machine comprising a user interface adapted to receive inputs from a user and present outputs to a user,
wherein the self-service machine is adapted to allow a user to perform any one or more the following operations:
register a company,
change company name,
register for healthcare,
complete immigration clearance,
apply for a passport,
apply for driver's license,
renew a drivers license,
apply for a certificate of absence of marriage record,
apply for road permits,
file an individual tax return,
apply for welfare,
wherein the self-service machine is configured to implement the authentication engine.

14. A computer-implemented method for authenticating a user on a device during a session comprising:
receiving input data from the input device
detecting a user's presence in the input data,
starting a countdown timer if no user presence is detected,
continuously detecting a user's presence during the countdown timer,
ending the session if a user's presence is not detected during the countdown timer and the timer reaches its end, and;
re-authenticating a user and keep the session active if a user's presence is detected during the countdown timer.

15. The method of claim 14, wherein a user is continuously reauthenticated each time a user's presence is detected while the countdown timer is on, wherein the countdown timer is reset if a user is successfully re-authenticated, and; the countdown timer duration is 1 minute or less.

16. The method of claim 15, wherein the input data is a video stream from a thermal or IR camera,
wherein the user's presence is detected by identifying an intrusion in the input data, wherein the intrusion is a human intrusion,
wherein detecting an intrusion comprises detecting human features within the video stream, and;
wherein the human features detected are facial features and movement of the facial features.

17. The method of claim 15, wherein authenticating a user comprises confirming the user is an active user based on the user's head position and one or more of facial expressions, movement of facial features, posture or arm movements, wherein the head position confirms the user is actively using the device.

18. The method of claim 16, comprising the additional steps of:
updating the status of a user to not detected if no intrusion is detected in the input data,
checking if continuous reauthentication is required for the role of the user prior to starting a countdown timer,
starting a countdown timer if it is determined that continuous reauthentication is required for the role,
wherein the role corresponds to the function being performed by the user on the device.

19. A self-service machine for allowing a user to perform one or more functions comprising:
a body,
a user interface disposed on the body,
the user interface adapted to receive inputs from the user and present outputs or information to the user,
the user interface being angled such that a standing user or a user seated in a wheelchair can interact with the user interface,
a memory unit and a processor, the processor operatively coupled to the memory unit,
an input device configured to capture and transmit input data,
the processor operatively coupled to the input device,
the processor comprising an authentication engine executable by the processor,
the authentication engine configured to:
receive input data from the input device,
detect a user's presence in the input data,
start a countdown timer if no user presence is detected,
continuously detect a user's presence during the countdown timer,
end the session if a user's presence is not detected during the countdown timer and the timer reaches its end, and;
re-authenticate a user and keep the session active if a user's presence is detected during the countdown timer,
continuously reauthenticate the user each time a user's presence is detected while the countdown timer is on, and;
reset the countdown timer if a user is successfully re-authenticated, and;
wherein the countdown timer duration is 1 minute or less.

20. The self-service machine of claim 19, wherein the body comprises a recessed portion to accommodate a wheelchair user's legs when the wheelchair user is adjacent the machine and using the machine, and the authentication engine of the self-service machine includes:
an input device configured to capture and transmit input data,
a processor operatively coupled to the input device, the processor comprising an authentication engine executable by the processor, the authentication engine configured to:
receive input data from the input device,
detect a user's presence in the input data,
start a countdown timer if no user presence is detected,
continuously detect a user's presence during the countdown timer,
end the session if a user's presence is not detected during the countdown timer and the timer reaches its end, and;
re-authenticate a user and keep the session active if a user's presence is detected during the countdown timer, wherein the device is a self-service machine comprising a user interface adapted to receive inputs from a user and present outputs to a user, wherein the self-service machine is adapted to allow a user to perform any one or more the following operations:
register a company,
change company name,
register for healthcare,
complete immigration clearance,
apply for a passport,
apply for driver's license,
renew a drivers license,
apply for a certificate of absence of marriage record,
apply for road permits,
file an individual tax return,
apply for welfare, wherein the self-service machine is configured to implement the authentication engine.
